(19) United States
(12) Patent Application Publication
(10) Pub. No.: US 2007/0206482 A1
(43) Pub. Date: Sep. 6, 2007

(54) Method and apparatus for reproducing optical recording medium

(75) Inventors: Tsutomu Aoyama, Tokyo (JP); Toshiki Aoi, Tokyo (JP)

Correspondence Address: MATHEWS, SHEPHERD, MCKAY, & BRUNEAU, P.A., 29 THANET ROAD, SUITE 201, PRINCETON, NJ, 08540, US

(73) Assignee: TDK Corporation

(21) Appl. No.: 11/713,222

(22) Filed: Mar. 2, 2007

(30) Foreign Application Priority Data
Mar. 2, 2006 (JP) 2006-056849

(51) Int. Cl. G11B 7/00

(52) U.S. Cl. 369/116; 369/53.26

(57) ABSTRACT

When the recording capacity of an optical recording medium is increased, both reproduction characteristics and a tilt margin are improved. Specifically, when a laser beam is projected onto an information recording layer of the optical recording medium to reproduce information, a laser beam having a wavelength of 400 to 410 nm is employed. In addition, an objective lens which converges the laser beam and has a numerical aperture NA of 0.70 to 0.90 is employed. The reproduction is started by projecting the laser beam. A reproduction signal obtained by projecting the laser beam is decoded by means of a PRML detection method to generate reproduction data of the optical recording medium. When the quality of the reproduction data deteriorates, the power of the laser beam is temporarily increased.

### BACKGROUND OF THE INVENTION

1. Field of the Invention

The present invention relates to a method and apparatus for reproducing signals from an optical recording medium and more particularly to a reproduction method or the like which allows increased recording density.

2. Description of the Related Art

Conventionally, CDs and DVDs have been widely used as optical recording media. The recording capacity required for such optical recording media has been increasing every year, and various ideas have been proposed to meet the requirement. In recent years, in order to further increase recording density, new standards such as the Blu-ray disc standard have been proposed. In the Blu-ray disc standard, a reduction in the beam spot diameter of a laser beam used for recording and reproducing data is realized. Specifically, the numerical aperture (NA) of an objective lens for converging the laser beam is increased, and the wavelength λ of the laser beam is reduced. Consequently, 25 GB of information can be recorded in an information recording layer.

Currently, in the Blu-ray disc standard, a determination is made whether or not a reproduction signal obtained by projecting the beam spot of a laser beam crosses a bit decision level (a slice level), and the signal is reproduced based on that determination.

Furthermore, in order to make the determination based on the bit decision level, the carrier-to-noise ratio (CN ratio) of the reproduction signal is important. However, when the size of recording marks is reduced in order to increase the recording density of an optical recording medium, the size of recording marks approaches a resolution limit determined by the beam spot diameter. Therefore, the CN ratio of the reproduction signal is likely to deteriorate. When the CN ratio of the reproduction signal deteriorates, the reproduction of signals based on a slice level becomes difficult. Hence, in the standard adopted for other optical recording media, signals are reproduced by means of a PRML (Partial Response Maximum Likelihood) detection method which employs a Viterbi decoder or the like, and the quality of the signals is evaluated based on the error rate of the reproduction data. In some cases, test reproduction is performed by means of the PRML detection method to evaluate the quality of signals, and then reproduction is started after the initial power of the laser beam is optimized based on the evaluation value. In this manner, the power of the laser beam can be optimized. (See, for example, Japanese Patent Laid-Open Publications Nos. 2003-6872, 2003-51163, and 2002-245722.)

On a Blu-ray disc, the amount of information currently required to be recorded in an information recording layer often exceeds 25 GB. When the recording density of the information recording layer is increased, the quality of reproduction signals deteriorates, and thus determining a binary value by means of slice level detection becomes difficult. Hence, the PRML detection method may be adopted for reproducing signals. However, unfortunately, the adoption of the PRML detection method alone does not improve the reproduction quality satisfactorily.

Particularly, when the information recording layer is formed close to the surface of a medium, reproduction signals deteriorate significantly due to surface defects such as dust and fingerprints. Therefore, optimization of the initial power of a laser beam becomes difficult. Furthermore, if the initial power of a laser beam is set relatively high in order to avoid the deterioration of reproduction signals due to surface defects or the like, an optical recording medium is likely to be damaged over long periods of reproduction.

Moreover, when the recording density of the information recording layer is increased, the tilt margin of a laser beam on an optical recording medium (i.e., the allowance for an inclination angle error in the optical axis of the beam incident on the optical recording medium) becomes extremely small. Furthermore, the allowance is likely to vary depending on the reproduction time. Therefore, in standards such as the Blu-ray disc standard, there is a demand for appropriately limiting the deterioration of the tilt margin so as to improve the signal quality while the amount of information to be recorded is increased.

The present invention has been made in view of the foregoing problems, and it is an object of the invention to provide a method and the like for reproducing an optical recording medium where the method can flexibly cope with deterioration in reproduction signals.

### SUMMARY OF THE INVENTION

The present inventors have conducted intensive studies and have found that the reproduction characteristics of signals can be improved by decoding the reproduction signals from an optical recording medium by means of a PRML detection method and by temporarily increasing read power according to the quality of reproduction data. At the same time, the inventors have found that, when the read power is increased, a tilt margin during high density recording can be significantly improved. Accordingly, the above object can be achieved by the following means obtained by the intensive studies by the inventors.

A first aspect of the present invention for achieving the foregoing object is a method for reproducing information by projecting a laser beam onto an information recording layer of an optical recording medium. In this method, reproduction is started by projecting the laser beam, the laser beam having a wavelength of 400 to 410 nm and being converged by an objective lens having a numerical aperture NA of 0.70 to 0.90, and a reproduction signal obtained by projecting the laser beam is decoded by means of a PRML detection method to thereby obtain reproduction data of the optical recording medium. The method includes temporarily increasing the power of the laser beam when a quality of the reproduction data deteriorates.

A second aspect of the present invention for achieving the foregoing object is a method for reproducing information by projecting a laser beam onto an information recording layer of an optical recording medium. The method includes the steps of:

starting reproduction by projecting the laser beam with a predetermined initial power, the laser beam having a wavelength of 400 to 410 nm and being converged by an objective lens having a numerical aperture NA of 0.70 to 0.90;

decoding a reproduction signal obtained by projecting the laser beam by means of a PRML detection method to thereby obtain reproduction data of the optical recording medium;

evaluating a quality of the reproduction data;

determining whether or not the quality of the reproduction data satisfies a reference value; and

increasing the power of the laser beam so that the power becomes greater than the initial power when the quality of the reproduction data does not satisfy the reference value.

A third aspect of the present invention for achieving the foregoing object is the reproduction method according to the second aspect, further including the step of further increasing the power when the quality of the reproduction data obtained by increasing the power of the laser beam does not satisfy the reference value.

A fourth aspect of the present invention for achieving the foregoing object is the reproduction method according to the second or third aspect, further including the step of decreasing the power of the laser beam after the power is increased.

A fifth aspect of the present invention for achieving the foregoing object is the reproduction method according to the second, third, or fourth aspect, further including the step of, after the power of the laser beam is increased, decreasing the power when the quality of the reproduction data satisfies the reference value for a predetermined period of time or for a period of time to reproduce a predetermined amount of information.

A sixth aspect of the present invention for achieving the foregoing object is the reproduction method according to any of the second to fifth aspects, wherein an error rate of the reproduction data is employed as the reference value.

A seventh aspect of the present invention for achieving the foregoing object is the reproduction method according to any of the second to fifth aspects, wherein an SAM value is employed as the reference value.

An eighth aspect of the present invention for achieving the foregoing object is a reproduction method according to any of the second to seventh aspects, wherein a reference class of the PRML detection method is a constraint length 5 (1, 2, 2, 2, 1).

A ninth aspect of the present invention for achieving the foregoing object is the reproduction method according to any of the second to eighth aspects, wherein the power after being increased is 0.50 mW or more.

A tenth aspect of the present invention for achieving the foregoing object is the reproduction method according to any of the second to ninth aspects, wherein the power after being increased is 0.60 mW or more.

An eleventh aspect of the present invention for achieving the foregoing object is the reproduction method according to any of the second to tenth aspects, wherein a minimum mark length recorded in the information recording layer is 125 nm or less.

An twelfth aspect of the present invention for achieving the foregoing object is an apparatus for reproducing an optical recording medium, including: a laser beam source which generates a laser beam having a wavelength of 400 to 410 nm; a laser controller which controls a power of the laser beam; an objective lens which converges the laser beam and has a numerical aperture NA of 0.70 to 0.90; a photodetector which detects a reflection beam of the laser beam; a PRML processing unit which decodes, by means of a PRML detection method, a reproduction signal detected by the photodetector; quality determination means which determines whether or not a quality of the reproduction data obtained by the PRML processing unit satisfies a reference value; and power instructing means which instructs the laser controller to increase the power of the laser beam when the quality of the reproduction data does not satisfy the reference value.

According to the reproduction method and the reproduction apparatus of the present invention, the following advantageous effect can be obtained. That is, when the recording capacity or the recording density of an optical recording medium is increased, the changes in the signal quality during reproduction can be smoothly addressed.

### BRIEF DESCRIPTION OF THE DRAWINGS

The above and other objects, features and advantages The above and other objects, features and advantages of the present invention will become apparent from the following description and appended claims, taken in conjunction with the accompanying drawings.

FIG. 1 is a block diagram illustrating an optical recording medium reproduction apparatus of an example of an embodiment of the present invention.

FIG. 2 is a set of a perspective view and an enlarged cross-sectional view illustrating the structure of an optical recording medium.

FIG. 3 is a set of enlarged perspective views each illustrating a data storage form in the information recording layer of the optical recording medium.

FIG. 4 is a flowchart illustrating a reproduction processing procedure of the reproduction apparatus.

FIG. 5 is a graph showing an example of changes in read power in the reproduction processing performed by the reproduction apparatus.

FIG. 6 is a flowchart illustrating another reproduction processing performed by the reproduction apparatus.

FIG. 7 is a graph showing another example of changes in read power in the reproduction processing performed by the reproduction apparatus.

FIG. 8 is a set of a table and a graph showing the relationship between an error rate and a read laser power during reproduction performed by the reproduction apparatus.

FIG. 9 is a set of a table and a graph showing the relationship between a tilt margin and a read laser power during reproduction performed by the reproduction apparatus.

### DETAILED DESCRIPTION OF THE PREFERRED EMBODIMENTS

Examples of the preferred embodiments of the present invention will now be described in detail with reference to the drawings.

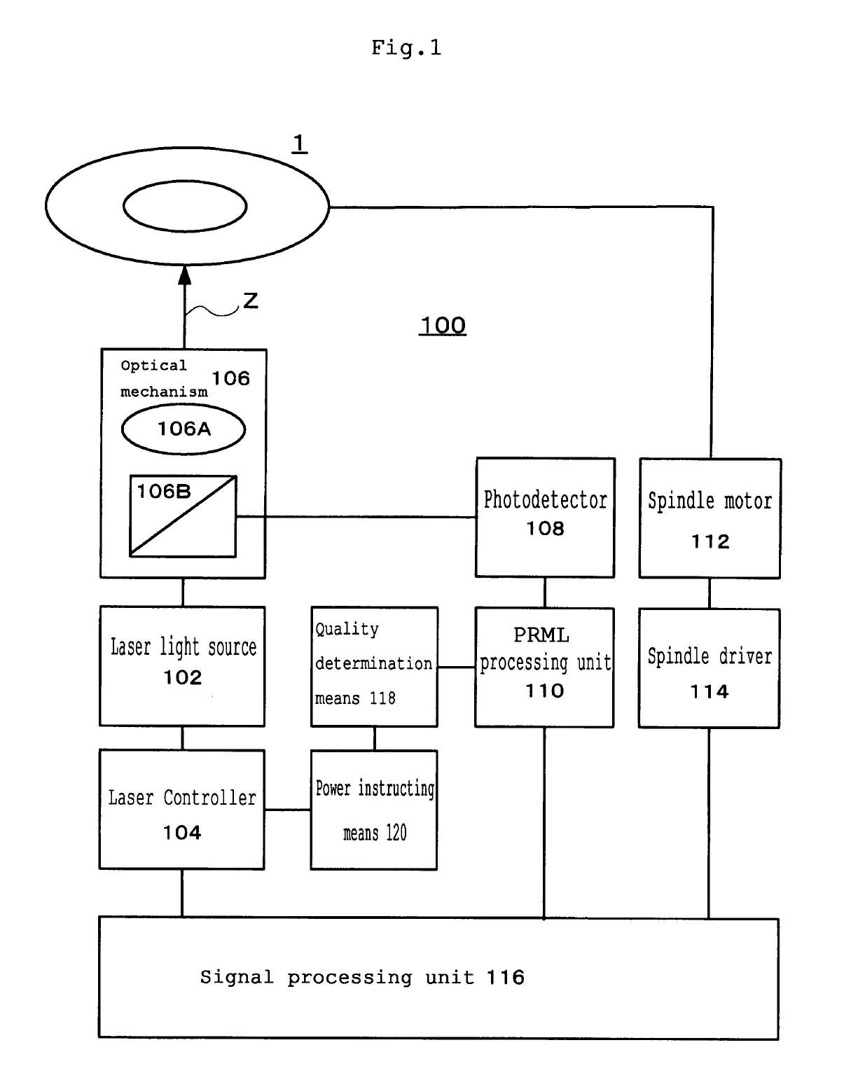

FIG. 1 shows a reproduction apparatus 100 which embodies a reproduction method according to an embodiment of the present invention. The reproduction apparatus 100 includes: a laser beam source 102 which generates a laser beam Z utilized for reproduction; a laser controller 104 which controls the laser beam source 102; an optical mechanism 106 which guides the laser beam Z onto an optical recording medium 1; a photodetector 108 which detects a reflection beam of the laser beam Z; a PRML processing unit 110 which decodes the information detected by the photodetector 108 by means of a PRML detection method; a spindle motor 112 which rotates the optical recording medium 1; a spindle driver 114 which controls the rotation of the spindle motor 112; a signal processing unit 116 which exchanges decoded reproduction data with a CPU (central processing unit, not shown); quality determination means 118 which evaluates the quality of reproduction data based on the information obtained by the decoding process performed by the PRML processing unit 110; and power instructing means 120 which instructs the laser controller 104 to change the power based on the results from the quality determination means 118.

The laser beam source 102 is a semiconductor laser and is controlled by the laser controller 104 to generate the laser beam Z. The optical mechanism 106 is provided with an objective lens 106A and a half mirror 106B and appropriately adjusts the focus of the laser beam Z onto an information recording layer. The half mirror 106B extracts the beam reflected from the information recording layer and directs the reflection beam to the photodetector 108. The photodetector 108 receives the reflection beam of the laser beam Z and converts the received beam to an electrical signal. This electrical signal is output to the PRML processing unit 110 as a reproduction signal. The PRML processing unit 110 decodes the reproduction signal and outputs a binary digital signal obtained from decoding to the signal processing unit 116 as reproduction data.

Furthermore, in the reproduction apparatus 100, the wavelength of the laser beam Z is set to between 400 and 410 nm. The initial read power of the laser beam Z is set to 0.35 mW. In addition, the numerical aperture NA of the objective lens 106A of the optical mechanism 106 is set to between 0.70 and 0.90. To initiate reproduction of information in the optical recording medium 1, the laser beam Z set at the initial read power is generated from the laser beam source 102. The laser beam Z is projected onto the information recording layer of the optical recording medium 1 to thereby initiate reproduction. The laser beam Z is reflected from the information recording layer, extracted through the optical mechanism 106, and converted to an electrical signal by the photodetector 108. The electrical signal is converted to a digital signal through the PRML processing unit 110 and the signal processing unit 116 and is then provided to the CPU.

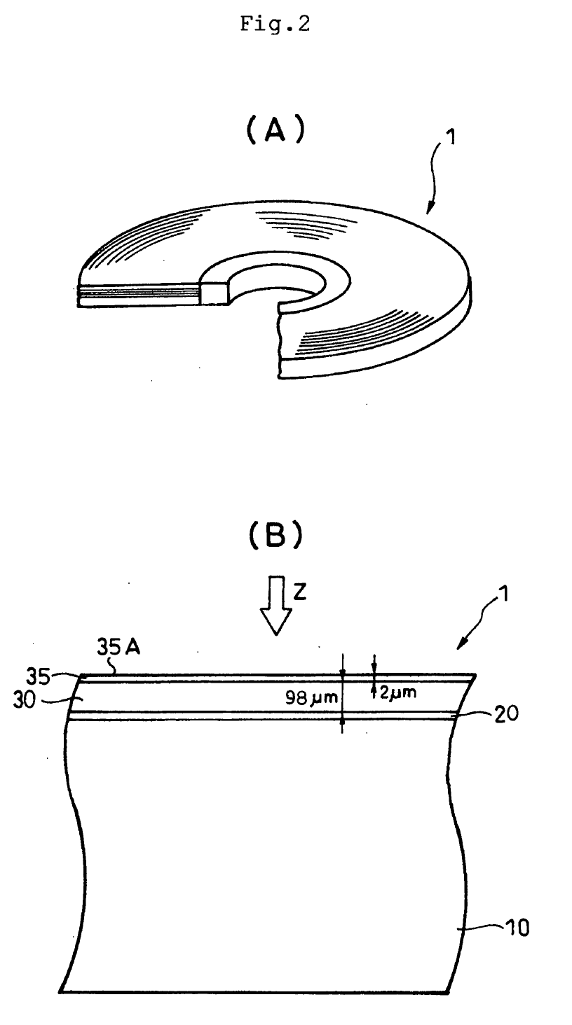

Next, a description will be given of the optical recording medium 1 to be reproduced by the reproduction apparatus 100. As shown in FIG. 2(A), the optical recording medium 1 is a disc-like medium having an outer diameter of approximately 120 mm and a thickness of approximately 1.2 mm. As enlarged in FIG. 2(B), the optical recording medium 1 is configured to include a substrate 10, the information recording layer 20 shown as a single layer, a cover layer 30, and a hard coat layer 35, all of which are laminated in that order.

The cover layer 30 and the hard coat layer 35 are transparent and thus allow the laser beam Z incident from the outside to pass therethrough. Therefore, the laser beam Z incident on a light incident surface 35A passes through the hard coat layer 35 and the cover layer 30 in this order and reaches the information recording layer 20, whereby the information stored in the information recording layer 20 is reproduced. In this optical recording medium 1, the recording capacity of the information recording layer 20 is set to 33.3 GB.

The substrate 10 is a disc-like member having a thickness of approximately 1.1 mm, and various materials such as glass, ceramic, and resin can be used as the material therefor. In this case, a polycarbonate resin is used. Examples of the resin which can be used include, in addition to the polycarbonate resin, an olefin resin, an acrylic resin, an epoxy resin, a polystyrene resin, a polyethylene resin, a polypropylene resin, a silicone resin, a fluororesin, an ABS resin, and a urethane resin. Of these, the polycarbonate resin and the olefin resin are preferable in terms of workability and moldability. Furthermore, on the surface of the substrate 10 on the information recording layer side there is formed a groove and land, a pit row, or the like, depending on the applications.

Various materials may be used as the material for the cover layer 30. However, a transparent material must be used for passing the laser beam Z therethrough as described above. Preferably, a UV-curable acrylic resin, for example, is used. Furthermore, in this optical recording medium 1, the thickness of the cover layer 30 is set to 98 μm, and the thickness of the hard coat layer 35 is set to 2 μm. Therefore, the distance between the light incident surface 35A and the information recording layer 20 is approximately 100 μm. Hence, the optical recording medium 1 conforms to the standard of the current Blu-ray disc except for the recording capacity (25 GB at the time of the present application).

The information recording layer 20 is a layer for storing data. The data storage forms include a reproduction-only type in which data is written in advance and cannot be overwritten and recording types in which a user can write data. Furthermore, the recording types include a write-once type and a rewritable type. In the write-once type, data cannot be rewritten in the area in which data have already been written. In the rewritable type, the written data can be erased, and data can be rewritten on the same area. In this embodiment, the information recording layer 20 may be the reproduction-only type or the recording type.

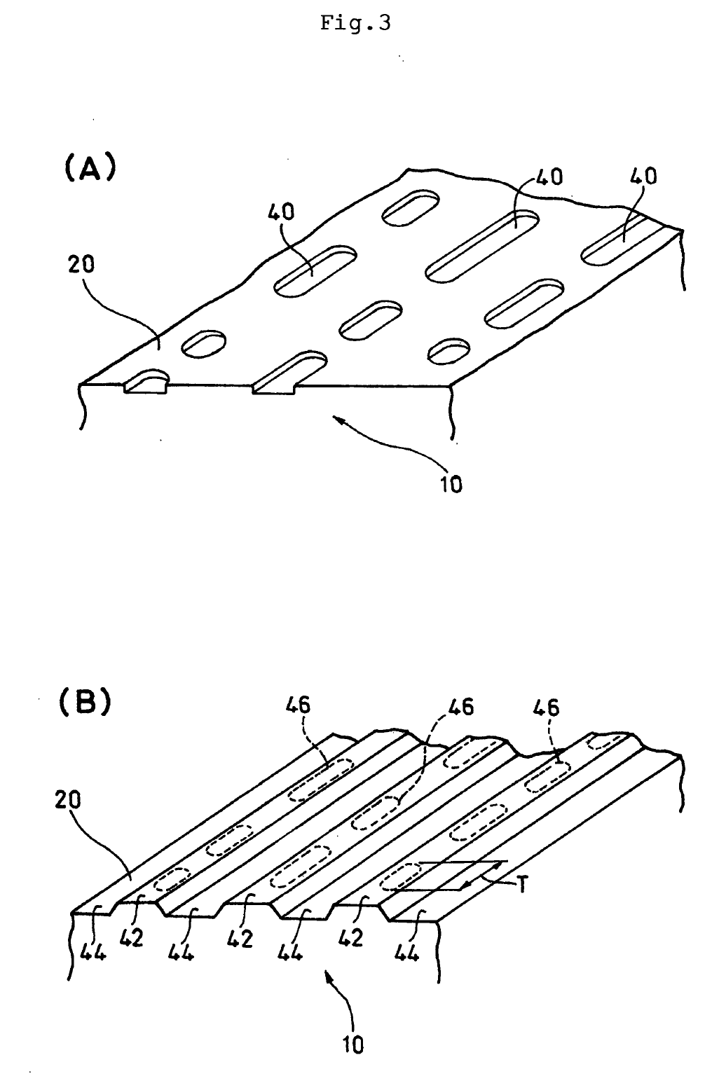

As shown in FIG. 3(A), when the data storage form of the information recording layer 20 is the reproduction only type, a spiral pit row 40 is formed on the substrate 10, whereby information is stored. In this case, a reflection film is formed on the information recording layer 20. During reproduction, the laser beam Z is reflected from the reflection film on the information recording layer 20, and the light reflectivity of the reflection film varies along the pit row 40 being in contact with the information recording layer 20. Therefore, the data in the pit row 40 can be read by measuring the changes in the reflection beam.

Alternatively, when the data storage form of the information recording layer 20 is the recording type, a spiral groove 42 (a land 44) is formed on the surface of the substrate 10 as shown in FIG. 3(B). In this case, in the information recording layer 20 a recording film is provided in which recording marks 46 can be formed depending on the energy of the laser beam Z. The land 44 serves as a guide track for the laser beam Z during data recording. When the energy intensity of the laser beam Z moving along the groove 42 is modulated, recording marks 46 are formed in the information recording layer 20 on the groove 42 depending on the energy intensity. When the data storage form is the write-once type, the recording marks 46 are formed irreversibly and cannot be erased. Conversely, when the data storage form is the rewritable type, the recording marks 46 are formed reversibly and can be erased and re-formed. In the above cases, the recording marks 46 are formed on the groove 42. However, the recording marks 46 may alternatively be formed on the land 44 and may also be formed on both the groove 42 and the land 44.

The recording capacity of the information recording layer 20 is determined through a combination of the size (area) of a recording region and the recording density. There is a physical limit to the size of the recording region. Therefore, in this embodiment, the recording density is increased by increasing the linear density of the recording marks 46 as shown in FIG. 3(B). Specifically, the length of a unit recording mark 46 in the spiral direction is reduced. In other words, the recording capacity is increased by reducing a minimum mark length T in the spiral direction of the recording marks 46 formed in the information recording layer 20. In this embodiment, the minimum mark length T is set to between 106.5 nm and 124.3 nm, and more specifically to 111.9 nm. When the minimum mark length T is set to 124.3 nm, 30 GB of information can be stored in the information recording layer 20. Furthermore, when the minimum mark length T is set to 106.5 nm, 35 GB of information can be stored in the information recording layer 20.

Next, a description is given of the PRML (Partial Response Maximum Likelihood) detection method in the PRML processing unit 110. The PRML detection method estimates binary data recorded in the information recording layer 20 based on an analog electrical signal detected by the photodetector 108. In the PRML detection method, a reference class characteristic for PR (Partial Response) must be appropriately selected according to reproduction characteristics. In this case, a constraint length 5 (1, 2, 2, 2, 1) is selected as the reference class characteristic for PR. The characteristic of the constraint length 5 (1, 2, 2, 2, 1) is that a reproduction response from a sign bit “1” constrains five bits adjacent to each other and that the waveform of the reproduction response can be represented by a sequence “12221.” It is assumed that a reproduction response from various actually recorded sign bits is formed through a convolution computation of the sequences “12221.” For example, the response from a sign bit sequence of 00100000 is 00122210. Similarly, the response from a sign bit sequence of 00010000 is 00012221. Therefore, the response from a sign bit sequence of 00110000 is obtained through a convolution computation of the above two responses and is 00134431. Furthermore, the response from a sign bit sequence of 001110000 is 001356531.

The above responses using this class characteristic for PR assume an ideal state. In this sense, the above responses are referred to as an ideal response. Of course, since an actual response contains noise, the actual response will deviate from the ideal response. Therefore, an actual response containing noise is compared with various predetermined ideal responses, and an ideal response is selected such that the difference (distance) therebetween is minimized. Then, the selected ideal response is employed as a signal to be decoded. This system is referred to as ML (Maximum Likelihood) identification. In the case where a recorded sign bit “1” is reproduced, when a reproduction signal close to “12221” is obtained, the reproduction signal is subjected to the PRML identification processing using the constraint length 5 (1, 2, 2, 2, 1), whereby the reproduction signal can be converted to the ideal response “12221” and then reproduced as a decoded signal “1.”

In the ML identification, the Euclidean distance is employed as a criterion for computing the difference between an ideal response and an actual response. For example, the Euclidean distance E between an actual reproduction sequence A (=A0, A1, . . . , An) and an ideal response sequence B (=B0, B1, . . . , Bn) is defined as E=4√{(Ai−Bi)²}. Therefore, an actual response is compared with a plurality of pre-estimated ideal responses using the Euclidian distance, and the results are ranked according to Euclidian distances. Then, the ideal response having the smallest Euclidian distance (maximum likelihood ideal response) is selected and decoded.

Next, a description is given of the quality determination means 118 and the power instructing means 120. The quality determination means 118 receives the data in the decoding step of the PRML detection method in the PRML processing unit 110 and detects an error rate and an SAM (Sequenced Amplitude Margin) value by utilizing the received data to evaluate the quality of the reproduction data. Here, the SAM value is the difference between the Euclidean distance of the maximum likelihood ideal response and the Euclidean distance of the second most ideal response ranked behind the maximum likelihood ideal response. The quality determination means 118 determines whether or not the evaluation results obtained by utilizing the error rate and the SAM value satisfy a predetermined criterion, or whether or not an uncorrectable error occurs. In this manner, the quality of the reproduction data is determined, and the determination results are provided to the power instructing means 120 and the like. In this instance, the error rate and the SAM value are employed as examples of a value for satisfying the criterion, but the present invention is not limited thereto. The signal quality may be determined by other means. In addition, the determination results from the quality determination means 118 are also provided to the signal processing unit 116. The signal processing unit 116 determines, based on the determination results, whether or not the data already reproduced is being repeatedly reproduced.

Based on the determination results from the quality determination means 118, the power instructing means 120 can instruct the laser controller 104 to increase the read power by a predetermined value. In the instruction of this embodiment, the read power is increased in increments of 0.05 mW. Further, the quality determination means 118 then evaluates the signal quality of the reproduction data after the read power has been increased. If the quality of the reproduction data after the read power has been increased still does not satisfy the reference value, the power instructing means 120 instructs the laser controller 104 to further increase the power by 0.05 mW. As described above, the read power is sequentially increased so long as the signal quality still does not satisfy the reference value. However, an upper limit for the read power is provided in order to prevent damage occurring to the optical recording medium 1 during reproduction. When a predetermined amount of information has been reproduced after the power has been increased, the power instructing means 120 resets (decreases) the read power to an initial value.

When the read power is decreased, the read power may be decreased based on the determination as to how long a state is continuously maintained in which the quality of the reproduction data satisfies the reference value in the power instructing means 120. Specifically, it is determined whether or not the state in which the quality of the reproduction data satisfies the reference value is maintained for a predetermined period of time or until a predetermined amount of information is reproduced. When the above conditions are satisfied, it is desirable that the read power be successively decreased in decrements of 0.05 mW. In this manner, the power of the laser beam Z varies smoothly in the signal reproduction step, whereby the reproduction processing can be performed stably.

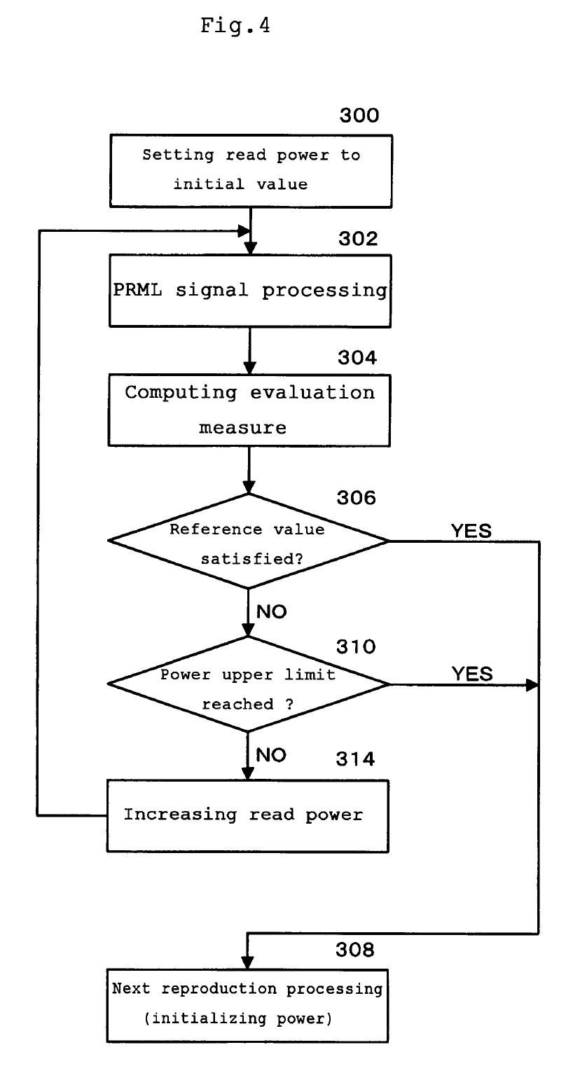

FIG. 4 shows a reproduction flowchart for the reproduction apparatus 100. In this case, a predetermined amount of reproduction data (an evaluation criterion information amount) is employed as a reproduction data group, and the reproduction processing is performed using this reproduction data group as a unit. Furthermore, the read power is reset to the initial value for each reproduction data group.

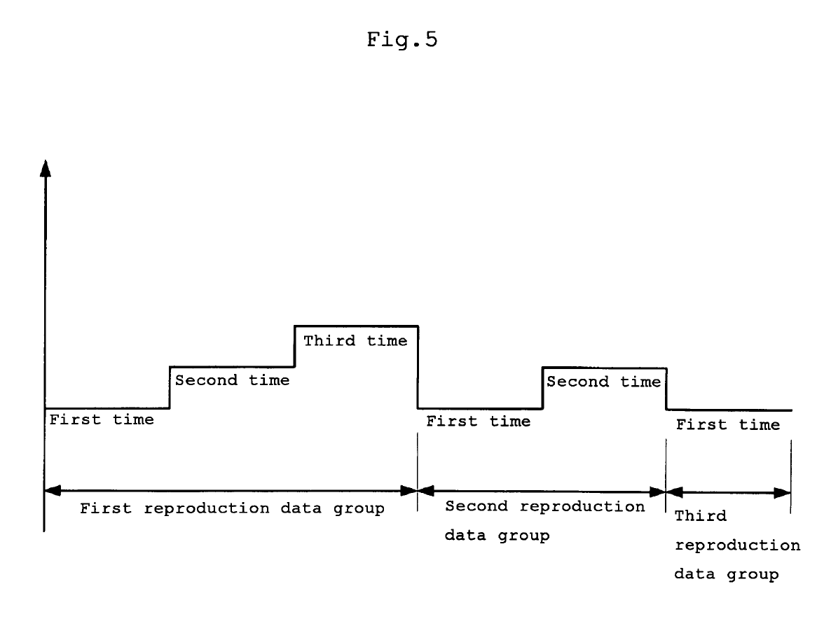

First, in step 300, the power instructing means 120 sets the read power to a predetermined initial value, and the laser beam Z is projected onto the optical recording medium 1, whereby the reproduction is started. In step 302, a reproduction signal is decoded by the PRML processing unit 110, and the decoded reproduction data is delivered to the signal processing unit 116. At the same time, in step 304, the signal quality of the reproduction data is computed in the quality determination means 118 by use of the SAM value. In step 306, it is determined whether or not the SAM value satisfies a reference value. If the above reproduction data group satisfies the reference value for quality, the process proceeds to step 308, and the power is initialized (for example, the read power is reset to the initial value). Then, the reproduction processing for the next reproduction data group is performed. However, if the above reproduction data group does not satisfy the reference value for quality in step 306, the process proceeds to step 310, and it is determined in the power instructing means 120 whether or not the current read power value has reached the upper limit. If the current read power has reached the upper limit, it is determined that the quality cannot be further improved by increasing the power, and the process proceeds to step 308. Then, the reproduction processing for the next reproduction data group is performed. If the read power has not reached the upper limit in step 310, the process proceeds to step 314, and the power instructing means 120 instructs the laser controller 104 to increase the read power by 0.05 mW. Subsequently, the process returns to step 302, and the same reproduction data group is again subjected to the reproduction processing. In this manner, as shown in FIG. 5, the read power is successively increased and the reproduction processing is repeated until the quality of the reproduction data satisfies the reference value. After completion of the reproduction of one reproduction data group, the read power is reset to the initial value, and the reproduction processing for the next reproduction data group is performed.

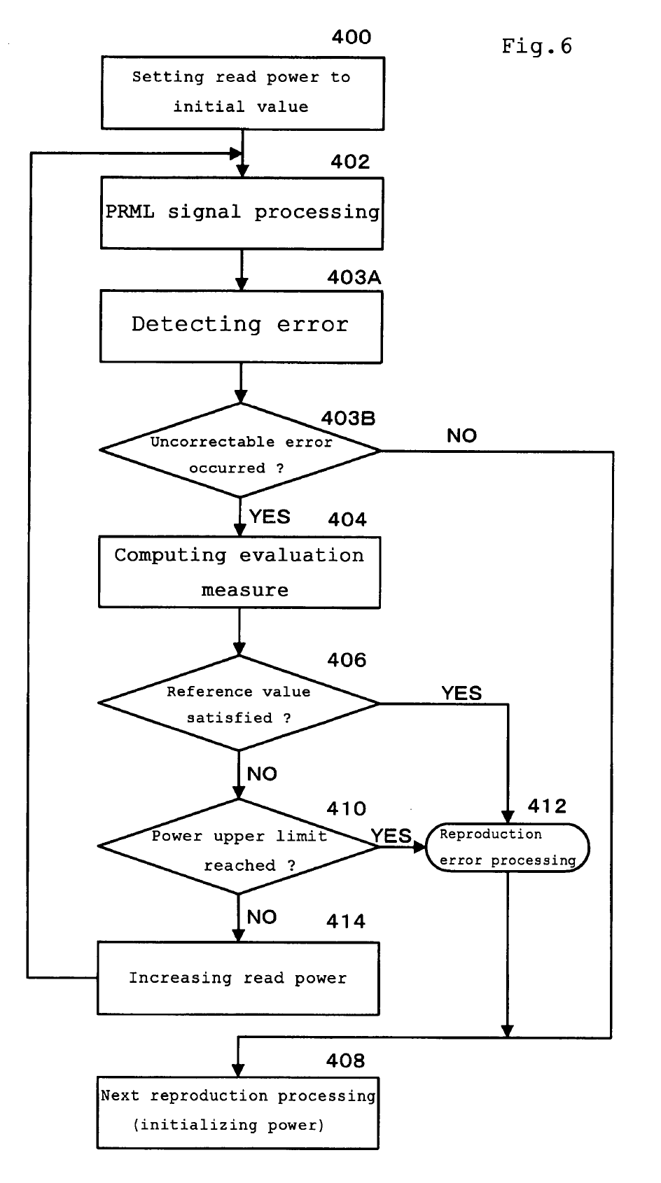

FIG. 6 shows another reproduction flowchart for the reproduction apparatus 100. Here, a description is given of the case in which the signal quality is evaluated utilizing the presence or absence of an uncorrectable error.

First, in step 400, the power instructing means 120 sets the read power to a predetermined initial value, and the laser beam Z is projected onto the optical recording medium 1, whereby the reproduction is started. In step 402, a reproduction signal is decoded by the PRML processing unit 110, and the reproduction data obtained from the decoding is provided to the signal processing unit 116. Subsequently, in step 403A, after the interleaved signal is restored to its original position in the signal processing unit 116, errors are corrected. Subsequently, in step 403B, it is determined whether or not any error which cannot be corrected in step 403A above (uncorrectable error) is present. If no uncorrectable error is present, i.e., the entire signal has been correctly reproduced, the process proceeds to step 408, and the power is initialized (for example, the read power is reset to the initial value). Then, the reproduction processing for the next reproduction data group is performed.

However, if an uncorrectable error is found in step 403B, the process proceeds to step 404, and the signal quality of the reproduction data is computed in the quality determination means 118 utilizing the error rate or the SAM value. In step 406, it is determined whether or not the value of the signal quality satisfies a quality reference value. If a determination is made that the quality of the reproduction data group satisfies the reference value for quality, an uncorrectable error is determined to have occurred due to a cause other than the signal quality. Thus, the process proceeds to step 412, and reproduction error processing is performed. In the reproduction error processing, complementing processing or the like is performed if the signal is moving image data. If the signal is computer data, a host computer is informed that an error has occurred. Subsequently, the process proceeds to step 408, and the next reproduction processing is performed.

If the signal quality of the reproduction data does not satisfy the reference value in step 406, the power instructing means 120 determines, in step 410, whether or not the current read power has reached the upper limit in. If the read power has already reached the upper limit, it is determined that the quality cannot be further improved by increasing the power. Then, the process proceeds to step 412, and reproduction error processing is performed. Subsequently, in step 408, the reproduction processing for the next reproduction data group is performed. If the read power has not reached the upper limit in step 410, the process proceeds to step 414, and the power instructing means 120 instructs the laser controller 104 to increase the read power by 0.05 mW. Subsequently, the process returns to step 402, and the same reproduction data group is again subjected to the reproduction processing.

In this manner, if an uncorrectable error occurs, the evaluation of the quality of an actual signal (step 404) and the determination of the quality reference value (step 406) are performed in accordance with need, and also the read power is increased (step 414) in accordance with need. Therefore, the signal reproduction processing can be simplified.

In FIGS. 4 to 6 and the like, when the reproduction processing for the next reproduction data group is performed, the read power is always initialized. However, the power can alternatively be decreased stepwise. For example, if the read power is not increased in the reproduction processing for the previous reproduction data group but the previous read power is larger than the initial power, the read power may be decreased by the power instructing means 120 by a predetermined decrement value (for example, 0.05 mW). Then, the reproduction processing for the next reproduction data group may be performed. On the other hand, if the read power is increased in the reproduction processing for the previous reproduction data group, it is determined that the quality of the reproduction data is still unstable, and thus the read power is maintained at the same level in the reproduction processing for the next reproduction data group.

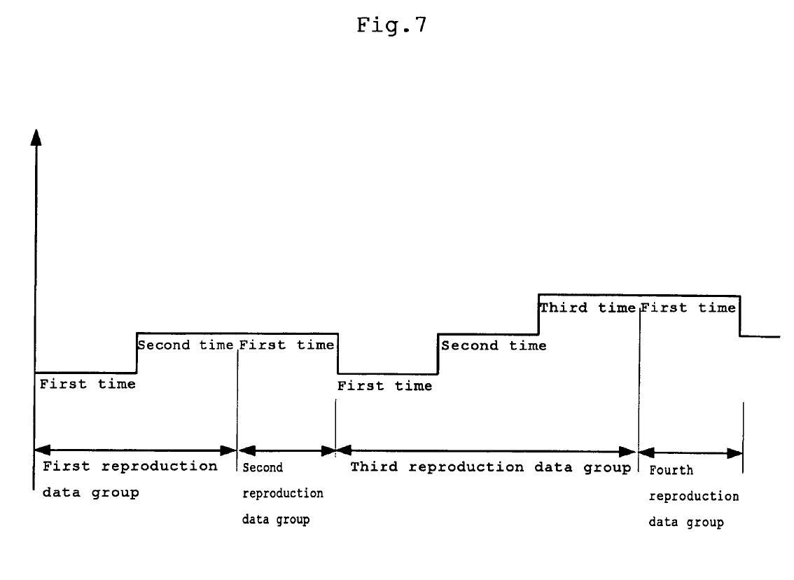

In this manner, as shown in, for example, FIG. 7, provided that increasing processing for the read power is not performed on two successive reproduction data groups, the read power can be smoothly decreased.

In the reproduction apparatus 100 according to the present invention, the PRML detection method in which the reference class is the constraint length 5 (1, 2, 2, 2, 1) is employed to perform the reproduction signal processing. At the same time, the read power of the reproduction laser beam Z can be temporarily increased during reproduction according to the quality of reproduction data. Consequently, when the PRML detection method with the constraint length 5 (1, 2, 2, 2, 1) is employed and also the laser power is temporarily increased, not only can the bit error rate (bER) in a reproduction signal be reduced, but also the tilt margin can be improved. The effects of the reduction of the bER and the improvement of the tilt margin are particularly significant when the recording capacity of the information recording layer 20 is 30 GB or more, preferably 33.3 GB or more, and more preferably 35 GB or more. That is, even when the recording capacity is increased, both the error rate and the tilt margin can be kept within a reasonable tolerance range.

For example, in the case in which the recording capacity is 25 GB, if the quality of reproduction data deteriorates, the tilt margin is hardly improved even when the read power is temporarily set to 0.45 mW or higher. Therefore, when the recording capacity is a conventional value (25 GB), the benefit from increasing the read power is low. However, when the recording capacity exceeds 30 GB, the increase of the read power contributes to the improvement of the tilt margin. Particularly, when an optical recording medium 1 having a recording capacity of 33.3 GB or more is reproduced and a conventional power (0.45 mW or less) is employed, an adequate tilt margin is not obtained. However, when the laser power level exceeds 0.45 mW, the tilt margin is significantly increased and exceeds a target tilt margin (0.2 deg or more). Furthermore, for example, even when the recording capacity is 35 GB or more, the bit error rate can be reduced to within a tolerance range (3.1×10⁻⁴ or less) by increasing the read power to 0.5 mw or more.

Furthermore, in this embodiment, so long as the quality of reproduction data is stable, the read power is not unnecessarily increased. Therefore, damaging of the optical recording medium 1 during reproduction can be reduced. This may also lead to a reduction in power consumption. In the optical recording medium 1, since the thickness of the cover layer 30 is small (98 μm), the distance between the light incident surface 35A and the information recording layer 20 is approximately 100 μm. In such a case, the signal quality is significantly affected by finger prints or the like adhering to the light incident surface 35A. However, since the area to which fingerprints adhere may only be a small portion of the optical recording medium 1, the changes in signal quality may not be detected during initial test reproduction or the like. Therefore, in this embodiment, the quality of reproduction data is evaluated during reproduction, and the read power is temporarily increased only in a region where the signal quality deteriorates. In this manner, the reproduction can be performed reliably. Furthermore, as shown in FIGS. 6 and 7, when the read power is increased, and also when the read power is decreased, the read power is changed by utilizing the quality evaluation results, such that actual surface defects and the like can be addressed smoothly.

### EXAMPLES

In order to examine the effects of temporarily increasing the read power, four samples of the optical recording medium 1 were produced which had different recording capacities (25 GB, 30 GB, 33.3 GB, and 35 GB). Then, by use of the reproduction apparatus 100 described above, the quality of a reproduction signal and the state of a tilt margin of each of the samples of the optical recording medium 1 were examined when read power was changed. The results are shown below.

First, in order to produce the optical recording medium 1, the substrate 10 was produced by means of an injection molding method. On the surface of the substrate 10 a spiral groove was formed with a track pitch of 0.32 μm. A polycarbonate resin was employed as the material for the substrate 10. The thickness was set to 1.1 mm, and the diameter was set to 120 mm.

Subsequently, the substrate 10 was placed in a sputtering apparatus, and the information recording layer 20 having a thickness of 50 nm was formed on the surface having the groove formed therein. The information recording layer 20 contained bismuth (Bi) and oxygen (O). The composition ratio (at. %) was set at Bi:O=32:68.

The substrate 10 having the information recording layer 20 formed thereon was placed in a spin coating apparatus, and an acrylic UV-curable resin was applied dropwise while the substrate 10 was rotated to thereby spin-coat the information recording layer 20. The substrate 10 was irradiated with ultraviolet rays to complete the cover layer 30 having a thickness of 98 μm. Furthermore, an UV-electron beam curable hard coat agent was applied to the cover layer 30 by means of a spin coating method. Subsequently, the applied hard coat agent was heated for three minutes in air to remove a diluent in the coating film, whereby an uncured hard coat material layer was formed. A solution of a surface material was applied to the uncured hard coat material layer by means of a spin coating method. The surface material solution was prepared by adding, to a fluorine-based solvent (99.5 parts by weight), perfluoropolyether diacrylate (0.33 parts by weight, molecular weight: approximately 2,000) and 3-perflurooctyl-2-hydroxypropyl acrylate (0.17 parts by weight). Subsequently, the hard coat material layer was dried at 60° C. for three minutes and irradiated with an electron beam under nitrogen flow to cure the hard coat material layer and the surface material solution at the same time, whereby a hard coat layer 35 was completed. Here, an electron beam was projected by means of an electron beam processing system (Curetron, product of NHV Corporation), and an electron beam acceleration voltage of 200 kV and an exposure of 5 Mrad were employed. The oxygen concentration in an irradiation atmosphere was 80 ppm. In this manner, the optical recording medium 1 was obtained.

Four samples (No. 1 to 4) of the thus-produced optical recording medium 1 were prepared, and random data was written on each of the samples at recording densities corresponding to 25 GB, 30 GB, 33.3 GB, and 35 GB, respectively. The minimum recording mark length of the optical recording medium 1 having a recording capacity of 25 GB was larger than 120 nm, and the minimum recording mark length of the optical recording medium 1 having recording capacities of 30 GB to 35 GB was 125 nm or less, specifically from 106.5 nm to 124.3 nm.

Subsequently, each of the samples No. 1 to 4 of the optical recording medium 1 was placed in the reproduction apparatus 100, and reproduction was performed at a data transfer rate of 72 Mbps (2×). The reproduction was performed while the read power was changed, and the quality of a reproduction signal (a bit error rate) was evaluated by means of an SbER evaluation method. Here, the SbER (Simulated bit Error Rate) evaluation method is one of evaluation methods utilizing an SAM value. Specifically, in the SbER evaluation method, the SAM value is computed for each of a plurality of reproduction signals, and the probability of misidentification is evaluated based on the mean and the standard deviation of a normal distribution obtained from a plurality of the SAM values. At this time, an SbER measurement unit (product of Pulstec Industrial Co., Ltd.) was used for the evaluation.

Furthermore, although not described in detail, a PRSNR (Partial Response Signal to Noise Ratio) evaluation method, for example, may be employed in addition to the SbER evaluation method. In the PRSNR evaluation method, the signal to noise ratio (SN ratio) of a reproduction signal and the degree of linearity between an actual reproduction signal and an ideal response can be represented simultaneously. The evaluation can be made by means of a PRSNR measurement board (product of Pulstec Industrial Co., Ltd.) or the like.

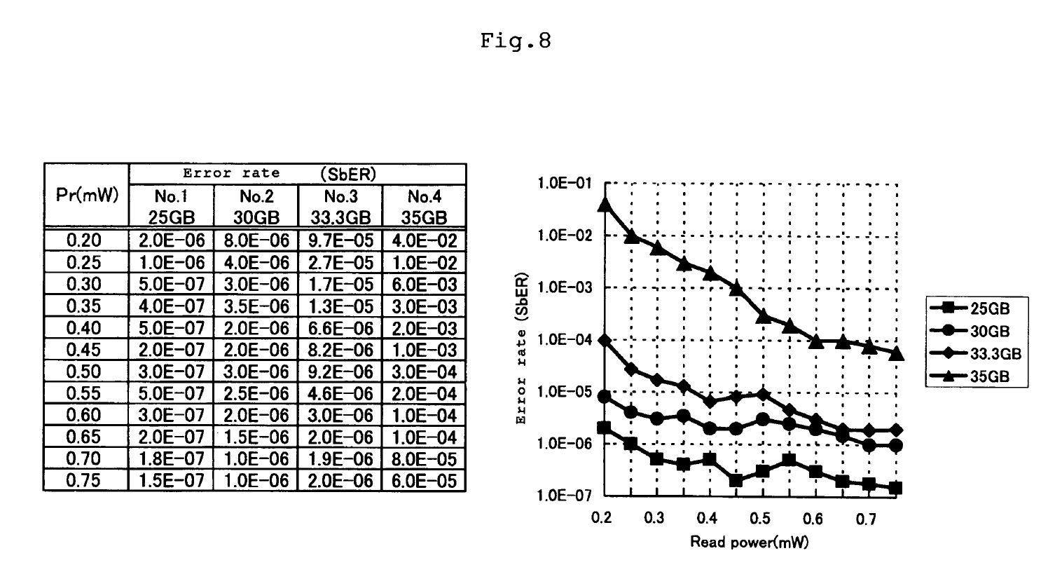

FIG. 8 shows the relationship between the error rate and the read laser power in the evaluation results obtained as above. In the reproduction method using the PRML detection method with the constraint length 5 (12221), it was found that the error rate was improved as the laser power was increased. Particularly, when the laser power was set to 0.5 mW or more, the error rate decreased for each of the optical recording media 1 having a recording capacity of 30 GB or more. When the laser power was set to 0.6 mW or more, the error rate decreased for all the optical recording media 1 including the one having a recording capacity of 25 GB. For the optical recording medium 1 having a recording capacity of 35 GB, the error rate can be reduced to below the tolerance limit (3.1×10⁻⁴) by setting the laser power to 0.5 mW or more.

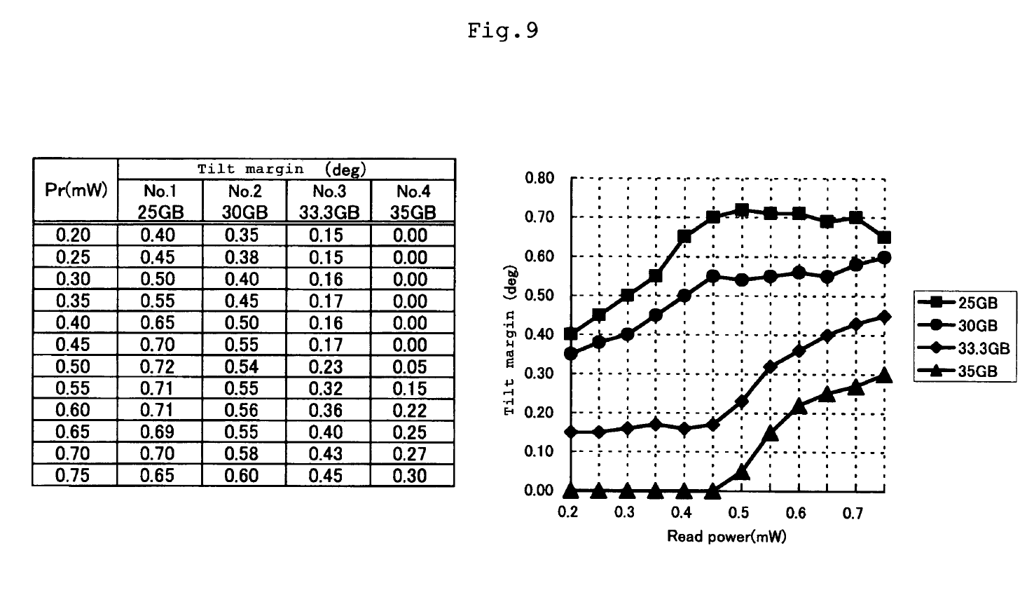

FIG. 9 shows the relationship between the tilt margin and the read laser power for the samples No. 1 to 4 of the optical recording medium 1. As is clear from the results, in the case of a recording capacity of 25 GB which is the recording capacity of the current Blu-ray disc standard, the tilt margin does not increase even when the read laser power exceeds the upper limit (0.45 mW) defined in the standard. However, when the recording capacity is 30 GB or more, the tilt margin increases even when the laser power exceeds 0.45 mW. That is, when the recording capacity is increased, the increase of the laser power contributes to the improvement of the tilt margin. Particularly, in the case where the recording capacity is 33.3 GB or more, when the read laser power is 0.45 mW or less, the tilt margin is below the target value of 0.2 deg, and thus the reproduction of signals is unstable. However, when the read laser power exceeds 0.45 mW, the tilt margin is significantly increased. For example, in the case where the recording capacity is 33.3 GB, the tilt margin can exceed the target value at a read laser power of 0.5 mW. Furthermore, in the case where the recording capacity is 35 GB, the tilt margin can exceed the target value at a read laser power of 0.6 mW.

According to the above results, when the PRML detection method in which the reference class is the constraint length 5 (1, 2, 2, 2, 1) is employed, and when the signal quality is lower than the reference value, the bit error rate (bER) in a reproduction signal can be significantly reduced by temporarily increasing the read power of the laser beam Z to 0.45 mW or more. Hence, improvement of the tilt margin can also be achieved. Particularly, these effects are significant when the recording capacity of the information recording layer 20 is 30 GB or more, preferably 33.3 GB or more, and more preferably 35 GB or more. That is, even when the recording capacity is increased, by employing the present reproduction apparatus 100, both the error rate and the tilt margin can be kept within a target range in accordance with need.

In the above embodiments of the present invention, the laser power during reproduction refers to the power supplied to the information recording layer. Furthermore, the present embodiments have been described only in the case where the information recording layer in an optical recording medium is laminated at a depth of 100 μm from a light incident surface, but the present invention is not limited thereto. The information recording layer may be laminated at another position.

The reproduction method of the present invention and the optical recording medium are not limited to those described in the above embodiments. Of course, various modifications may be made without departing from the spirit of the present invention.

According to the present invention, even when the recording capacity or the recording density of an optical recording medium is increased, the quality of reproduction signals can be improved.

The entire disclosure of Japanese Patent Application No. 2006-56849 filed on Mar. 2, 2006 including specification, claims, drawings, and summary are incorporated herein by reference in its entirety.

What is claimed is:

1. A method for reproducing an optical recording medium, in which information is reproduced by projecting a laser beam onto an information recording layer of an optical recording medium, the method including:
starting reproduction by projecting the laser beam, the laser beam having a wavelength of 400 to 410 nm and being converged by an objective lens having a numerical aperture NA of 0.70 to 0.90;
decoding a reproduction signal obtained by projecting the laser beam by means of a PRML detection method to thereby obtain reproduction data of the optical recording medium; and
temporarily increasing the power of the laser beam when a quality of the reproduction data deteriorates.

2. A method for reproducing an optical recording medium, in which information is reproduced by projecting a laser beam onto an information recording layer of an optical recording medium, the method comprising the steps of:
starting reproduction by projecting the laser beam with a predetermined initial power, the laser beam having a wavelength of 400 to 410 nm and being converged by an objective lens having a numerical aperture NA of 0.70 to 0.90;
decoding a reproduction signal obtained by projecting the laser beam by means of a PRML detection method to thereby obtain reproduction data of the optical recording medium;
evaluating a quality of the reproduction data;
determining whether or not the quality of the reproduction data satisfies a reference value; and
increasing the power of the laser beam so that the power becomes greater than the initial power when the quality of the reproduction data does not satisfy the reference value.

3. The method for reproducing an optical recording medium according to claim 2, comprising the step of further increasing the power when the quality of the reproduction data obtained by increasing the power of the laser beam does not satisfy the reference value.

4. The method for reproducing an optical recording medium according to claim 2, comprising the step of decreasing the power of the laser beam after the power is increased.

5. The method for reproducing an optical recording medium according to claims 2, comprising the step of, after the power of the laser beam is increased, decreasing the power when the quality of the reproduction data satisfies the reference value for a predetermined period of time or for a period of time to reproduce a predetermined amount of information.

6. The method for reproducing an optical recording medium according to claims 2, wherein an error rate of the reproduction data is employed as the reference value.

7. The method for reproducing an optical recording medium according to claims 2, wherein an SAM value is employed as the reference value.

8. The method for reproducing an optical recording medium according to claims 2, wherein a reference class of the PRML detection method is a constraint length 5 (1, 2, 2, 2, 1).

9. The method for reproducing an optical recording medium according to claims 2, wherein the power after being increased is 0.50 mW or more.

10. The method for reproducing an optical recording medium according to claims 2, wherein the power after being increased is 0.60 mW or more.

11. The method for reproducing an optical recording medium according to claims 2, wherein a minimum mark length recorded in the information recording layer is 125 nm or less.

12. The method for reproducing an optical recording medium according to claim 2, comprising the step of:
further increasing the power when the quality of the reproduction data obtained by increasing the power of the laser beam does not satisfy the reference value;
decreasing the power of the laser beam after the power is increased.

13. The method for reproducing an optical recording medium according to claim 2, comprising the step of:
further increasing the power when the quality of the reproduction data obtained by increasing the power of the laser beam does not satisfy the reference value;
after the power of the laser beam is increased, decreasing the power when the quality of the reproduction data satisfies the reference value for a predetermined period of time or for a period of time to reproduce a predetermined amount of information.

14. The method for reproducing an optical recording medium according to claim 2, comprising the step of further increasing the power when the quality of the reproduction data obtained by increasing the power of the laser beam does not satisfy the reference value;
wherein an error rate of the reproduction data is employed as the reference value.

15. The method for reproducing an optical recording medium according to claim 2, comprising the step of further increasing the power when the quality of the reproduction data obtained by increasing the power of the laser beam does not satisfy the reference value;
wherein an SAM value is employed as the reference value.

16. The method for reproducing an optical recording medium according to claim 2, comprising the step of further increasing the power when the quality of the reproduction data obtained by increasing the power of the laser beam does not satisfy the reference value;
wherein a reference class of the PRML detection method is a constraint length 5 (1, 2, 2, 2, 1).

17. The method for reproducing an optical recording medium according to claim 2, comprising the step of further increasing the power when the quality of the reproduction data obtained by increasing the power of the laser beam does not satisfy the reference value;
wherein the power after being increased is 0.50 mW or more.

18. The method for reproducing an optical recording medium according to claim 2, comprising the step of further increasing the power when the quality of the reproduction data obtained by increasing the power of the laser beam does not satisfy the reference value;
wherein the power after being increased is 0.60 mW or more.

19. The method for reproducing an optical recording medium according to claim 2, comprising the step of further increasing the power when the quality of the reproduction data obtained by increasing the power of the laser beam does not satisfy the reference value;
wherein a minimum mark length recorded in the information recording layer is 125 nm or less.

20. An apparatus for reproducing an optical recording medium, comprising:
a laser beam source which generates a laser beam having a wavelength of 400 to 410 nm;
a laser controller which controls a power of the laser beam;
an objective lens which converges the laser beam and has a numerical aperture NA of 0.70 to 0.90;
a photodetector which detects a reflection beam of the laser beam;
a PRML processing unit which decodes, by means of a PRML detection method, a reproduction signal detected by the photodetector;
quality determination means which determines whether or not a quality of the reproduction data obtained by the PRML processing unit satisfies a reference value; and
power instructing means which instructs the laser controller to increase the power of the laser beam when the quality of the reproduction data does not satisfy the reference value.
